(19) United States
(12) Patent Application Publication
(10) Pub. No.: US 2014/0085497 A1
(43) Pub. Date: Mar. 27, 2014

(54) Systems And Methods For Sychronizing Multiple Video Sensors

(71) Applicant: OMNIVISION TECHNOLOGIES, INC., Santa Clara, CA (US)

(72) Inventor: Jeffrey L. Morin, Lincoln Park, MI (US)

(73) Assignee: OMNIVISION TECHNOLOGIES, INC., Santa Clara, CA (US)

(21) Appl. No.: 13/627,648

(22) Filed: Sep. 26, 2012

(51) Int. Cl. H04N 5/232

(52) U.S. Cl. CPC H04N 5/23229
USPC 348/218.1

(57) ABSTRACT

A system and method for producing an image include a plurality of sensors detecting light from a subject being imaged, each sensor generating an associated video signal indicative of its detected light, each video signal comprising a predefined time interval. A decoder receives the video signals from their associated sensors, detects the predefined time intervals of the received video signals, generates a synchronization signal, and transmits the synchronization signal to each sensor during the predefined time interval of its associated video signal.

### BACKGROUND

1. Technical Field

This disclosure is related to video imaging systems having multiple video sensors and, more particularly, to an apparatus and method in video imaging systems for synchronizing multiple video sensors.

2. Discussion of the Related Art

In video imaging systems, such as automotive surround view systems, multiple video imagers or video cameras are used to create a single video image of a scene, such as, for example, the area surrounding an automobile. The video images from the multiple video cameras are “stitched” together to create the single video image. In many such systems, it is required that the video cameras output their video data in the form of an analog video signal. The advantage of an analog signal is lower cost compared to a pure digital system. However, one important issue with the analog-based system is how to synchronize the video cameras so they capture and transmit their video at the same time. If even one of the video cameras is out of synchronization, image tearing can occur in the final stitched video image. In such analog-based systems, whenever the system is powered up, the video cameras could in general be capturing video at different times.

In some conventional systems, the analog video image sensors can be synchronized by connecting wires between the frame sync inputs and outputs of each of the sensors. However, in some settings, such as the automotive vehicle application, it is very expensive to run a wire to each video camera.

### SUMMARY

According to one aspect, a system for producing an image is provided. The system includes a plurality of sensors for detecting light from a subject being imaged. Each sensor generates an associated video signal indicative of its detected light, with each video signal including a predefined time interval. A decoder receives the video signals from their associated sensors and detects the predefined time intervals of the received video signals. The decoder generates at least one synchronization signal and transmits the synchronization signal to at least one of the sensors during the predefined time interval of its associated video signal.

According to another aspect, a video decoder is provided. The video decoder includes a plurality of inputs for receiving a respective plurality of video signals from a respective plurality of associated sensors, with each video signal having a predefined time interval. A signal generating circuit generates at least one synchronization signal and transmits the synchronization signal to at least one of the sensors during the predefined time interval of its associated video signal.

According to another aspect, a method for producing an image is provided. According to the method, light from a subject being imaged is detected using a plurality of sensors. Each sensor generates an associated video signal indicative of its detected light, each video signal having a predefined time interval. The video signals are received from their associated sensors using a decoder. The decoder detects the predefined time intervals of the received video signals, generates at least one synchronization signal, and transmits the synchronization signal to at least one of the sensors during the predefined time interval of its associated video signal.

According to another aspect, a video decoding method is provided. According to the method, a plurality of video signals is received from a respective plurality of associated sensors, each video signal having a predefined time interval. At least one synchronization signal is generated and transmitting to at least one of the sensors during the predefined time interval of its associated video signal.

### BRIEF DESCRIPTION OF THE DRAWINGS

The foregoing and other features and advantages will be apparent from the more particular description of preferred embodiments, as illustrated in the accompanying drawings in which like reference characters refer to the same parts throughout the different views. The drawings are not necessarily to scale, emphasis instead being placed upon illustrating the principles of the disclosure. In the drawings, the sizes of features may be exaggerated for clarity.

FIG. 1 is a schematic diagram of a video imaging system, which, in the illustrated embodiment, is a surround view system incorporated into an automobile, according to some exemplary embodiments.

FIG. 2 is a schematic diagram of raster or line scanning of standard video image signals superimposed on a schematic diagram of a display.

FIG. 3 is a schematic diagram of an exemplary analog video image signal to which the present disclosure is applicable.

FIG. 4 is a detailed schematic block diagram of a video imaging system, according to some exemplary embodiments.

FIG. 5 contains a schematic flow diagram illustrating a process of synchronizing a plurality of video cameras being used in generating a composite video image, according to some exemplary embodiments.

### DETAILED DESCRIPTION

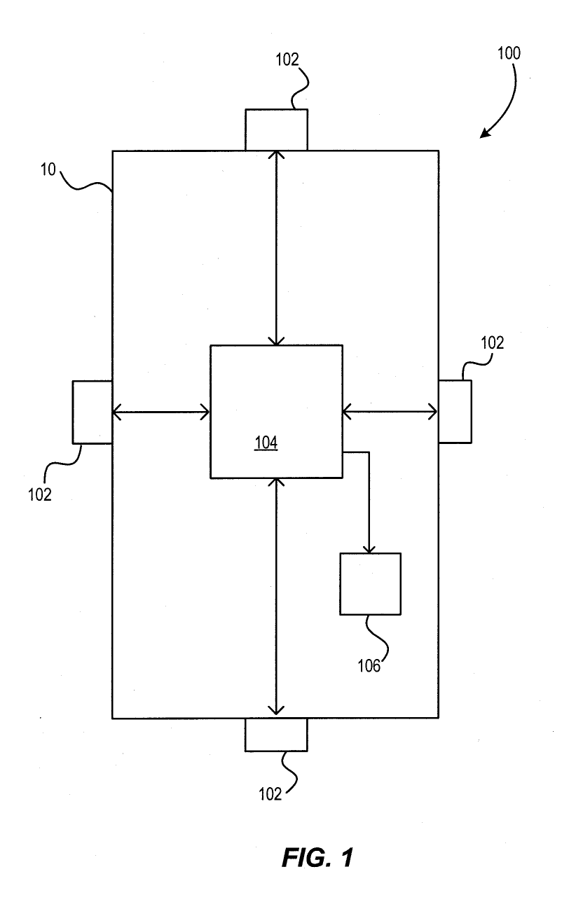

FIG. 1 is a schematic diagram of a video imaging system, which, in the illustrated embodiment, is a surround view system 100 incorporated into an automobile 10, according to some exemplary embodiments. It will be understood that the present disclosure is applicable to any type of video imaging system and that the automobile surround view imaging system is described herein by way of exemplary illustration only. Referring to FIG. 1, the video imaging system 100 includes a plurality of analog-based video imagers or video cameras 102, each of which generates a video image. In the particular illustrated exemplary embodiment, system 100 includes four video imagers or video cameras 102. It will be understood that the present disclosure is applicable to any number of video imagers or video cameras 102. It will also be understood that the terms “imager” and “camera” and any of their forms are used interchangeably herein.

Each video camera 102 generates a video image and forwards its video image via a standard analog video image signal, such as a National Television System Committee (NTSC) standard video image signal, to video image processing circuitry 104. Video image processing circuitry 104 “stitches” the four video images together to form a composite video image of the area surrounding the automobile 10. The composite video image can then be stored and/or displayed on a display device 106.

An important issue associated with generating the composite video image from the stitched individual images from the individual video cameras 102 is timing, i.e., synchronization, of the multiple individual video images. If the individual images are not in proper synchronization, then the composite video image will be a combination of individual images taken at different times. If even one of video cameras 102 is out of synchronization, then image tearing will result. The composite image will appear distorted due to the time difference.

One possible approach to synchronizing video cameras 102 would be to run wires between video cameras 102. The wires could be used to connect the frame synchronization inputs/outputs of video cameras 102 together. Unfortunately, this approach, particularly in the automobile manufacturing environment, would be prohibitively expensive.

According to some exemplary embodiments, a synchronization signal is transmitted from video image processing circuitry 104 to at least one of video cameras 102. Video camera 102 receiving the synchronization signal adjusts or resets its internal timing according to the synchronization signal, such that all of video cameras 102 can return to synchronization.

In some exemplary embodiments, the synchronization signal can be a simple pulse signal, which can be sent, in some embodiments, to some or all of video cameras 102. In response to the synchronization pulse signal, all of video cameras 102 can adjust or reset their internal timing based on the timing of the synchronization pulse signal such that all of video cameras 102 return to synchronization. In some exemplary embodiments, the pulse-type synchronization signal is transmitted to fewer than all of video cameras 102 to effect synchronization of all of video cameras 102. In some exemplary embodiments, the synchronization signal can include commands and/or data used by individual video cameras 102 to adjust their internal timing. These command-type synchronization signals can provide any number of video cameras 102 with timing adjustment instructions specific to particular video camera(s) 102. That is, a synchronization command signal specific to a single associated video camera 102 can be generated and transmitted to the associated video camera 102 to adjust the timing of that particular associated video camera 102. These specific command-type synchronization signals can be generated as needed for as many of video cameras 102 as necessary up to and including all of video cameras 102.

As described above, according to exemplary embodiments, video cameras 102 transmit their video image data via standard analog video image signals, such as NTSC standard video image signals, to video image processing circuitry 104. Video image processing circuitry 104 generates and transmits the synchronization signal to one or more of video cameras 102 during predetermined intervals of the video image signals. Specifically, in some embodiments, video image processing circuitry 104 transmits the synchronization signal(s) to video camera(s) 102 during the vertical blanking interval(s) of the associated video image signal(s) being transmitted to image processing circuitry 104 by the associated video camera(s) 102.

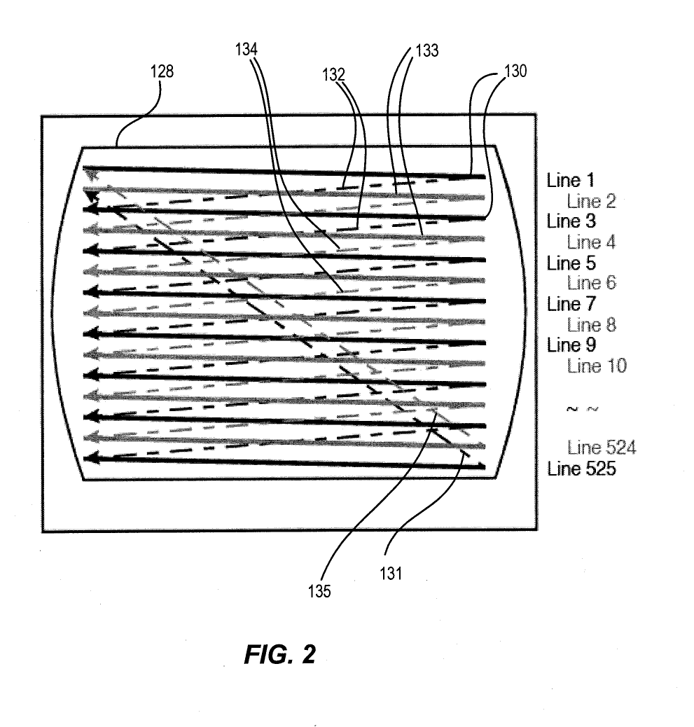

FIG. 2 is a schematic diagram of raster or line scanning of standard video image signals superimposed on a schematic diagram of a display 128. According to this specific exemplary embodiment, the video image signal is a standard NTSC video signal, and the raster or line scanning is in accordance with the NTSC standard. According to the NTSC standard, as illustrated in FIG. 2, a full frame includes 525 horizontal scan lines, of which 486 horizontal scan lines include actual analog video data used to generate the image on the display. The remaining 39 lines are not displayed. This period of 39 lines is referred to as the vertical blanking interval (VBI) or vertical interval or VBLANK of the video image signal. It is defined as the time difference between the last line of one frame or field of a raster display, and the beginning of the first line of the next frame or field. It is illustrated by the diagonal light and dark dashed arrows 131, 135 in FIG. 2.

Raster scanning occurs one horizontal scan line at a time. In actual scanning, all of the odd-numbered lines are scanned first, as indicated by the dark solid lines 130 in FIG. 2, such that the odd “field” is generated first. Then, the even field is generated by scanning the even-numbered horizontal scan lines, as indicted by the light solid lines 133 in FIG. 2. At the end of each horizontal scan line 130, 133, the scanning returns to the beginning of the next line (odd or even). The time period during which this occurs is referred to as the horizontal blanking interval (HBI), and is indicated by the dark and light dashed arrows 132, 134 in FIG. 2.

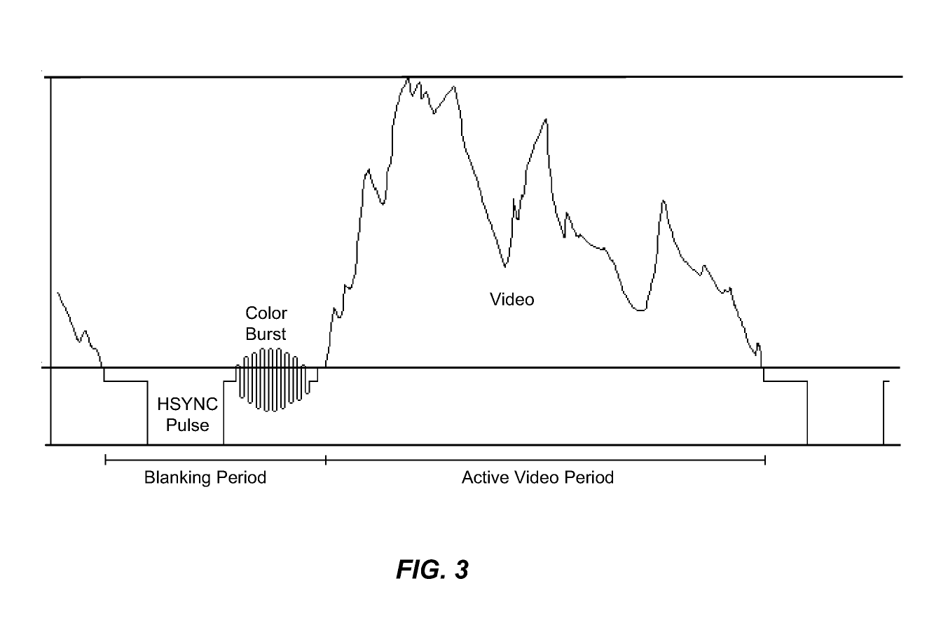

FIG. 3 is a schematic diagram of an exemplary analog video image signal to which the present disclosure is applicable. The video image signal in FIG. 3 represents the video image data for one horizontal scan line 1330, 133 illustrated in FIG. 2.

Referring to FIG. 3, the video image signal includes a blanking period, also commonly referred to, and referred to herein, as the horizontal blanking interval (HBI). During the HBI, the video image signal includes a horizontal synchronization (HSYNC) pulse, which signifies the upcoming analog video image data, and a color burst interval, which allows for synchronization of color information in the video image signal. After the HBI ends, the active video period of the signal, during which the actual analog video image data is scanned, begins. At the end of the active video period, the HBI of the next scan line or video image signal begins.

As described above, according to exemplary embodiments, the synchronization signal of the disclosure is transmitted by video image processing circuitry 104 to one or more of imagers or video cameras 102 during the VBI. In some other exemplary embodiments, the synchronization signal can be transmitted from video image processing circuitry 104 to imagers or video cameras 102 during one or more of the HBIs of one or more of the horizontal scan lines 130, 133.

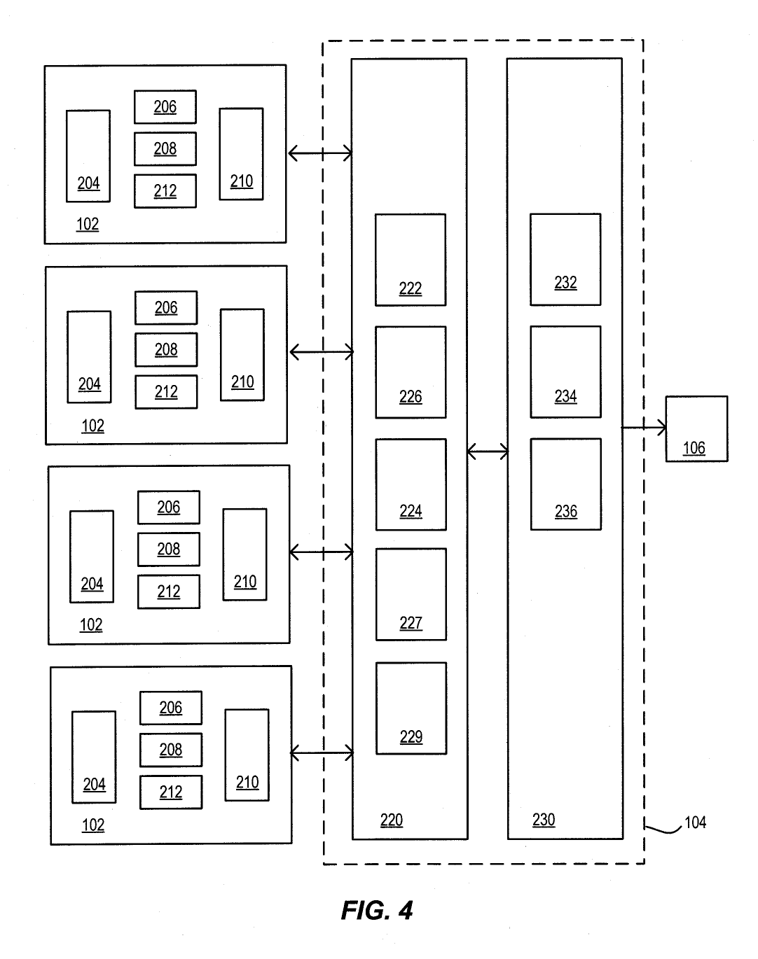

FIG. 4 is a detailed schematic block diagram of a video imaging system 100, according to some exemplary embodiments. As noted above, the detailed description herein refers to the system 100 as being a surround view system 100 incorporated into an automobile. As further noted above, it will be understood that the present disclosure is applicable to any type of video imaging system and that the automobile surround view imaging system is described herein by way of exemplary illustration only. Referring to FIG. 4, video imaging system 100 includes a plurality of analog-based video imagers or video cameras 102, each of which generates a video image. In the particular illustrated exemplary embodiment, system 100 includes four video imagers or video cameras 102. It will be understood that the present disclosure is applicable to any number of video imagers or video cameras 102.

Each video camera 102 generates a video image and forwards its video image via a standard analog video image signal, such as the NTSC standard video image signal illustrated in FIG. 3, to video image processing circuitry 104. Video image processing circuitry 104 “stitches” the four video images together to form a composite video image of the area surrounding the video cameras 102. The composite video image can then be stored and/or displayed on a display device 106.

Referring to FIG. 4, video image processing circuitry 104 can include a multi-channel video decoder 220, which, in the illustrated exemplary embodiment, can be a four-channel video decoder. Multi-channel video decoder 220 includes video decoding circuitry 222, which receives and decodes the video image signal from each video camera 102 and decodes the video image signal to generate digital image data for each video camera's video image signal from the analog image signal data. Multi-channel video decoder 220 can temporarily store the decoded digital image data for each video camera 102 in temporary storage memory 224.

Each video camera 102 includes a video image sensor 204, which detects the raw video image data from the scene being imaged and converts the light from the scene to an analog signal. Image processing circuitry 206 interfaces with memory circuitry 212 and synchronization circuitry 208 to generate the analog video image signal for the video camera 102. The analog video image signal for each video camera 102, as illustrated in FIG. 3, is forwarded out of video camera 102 via input/output circuitry 210 to video image processing circuitry 104. As described above, the signal is decoded by video decoding circuitry 222 in multi-channel video decoder 220.

Each video camera 102 includes synchronization circuitry 208, which adjusts the timing of the analog video image signal output by video camera 102. Synchronization circuitry 208 can include, for example, programmable registers, programmable timers, clocks and other such circuitry, used to programmably adjust the timing of the analog video image signal being generated and output by video camera 102. Multi-channel video decoder 220 in video image processing circuitry 104 also includes synchronization circuitry 226 used to adjust timing of one or more of video cameras 102. In some exemplary embodiments, synchronization circuitry 226 can include or interface with signal generation circuit 227, which generates and transmits the synchronization signal to one or more of video cameras 102, according to some exemplary embodiments. As described above, the synchronization signal is transmitted by synchronization circuitry 226 in multi-channel video decoder 220 of video image processing circuitry 104 to synchronization circuitry 208 in video camera(s) 102. The synchronization signal is processed by synchronization circuitry 208 in video camera(s) 102 to adjust the timing of the analog video image signal such that all of the analog video image signals from all video cameras 102 are synchronized.

As described above in detail, in some exemplary embodiments, the synchronization signal can be a simple pulse signal, which can be sent, in some embodiments, to all of video cameras 102. In response to the pulse-type synchronization signal, synchronization circuitry 208 in all of video cameras 102 can adjust or reset their internal timing based on the timing of the pulse-type synchronization signal such that all of video cameras 102 return to synchronization. In some exemplary embodiments, the pulse-type synchronization signal is transmitted to fewer than all of video cameras 102 to effect synchronization of all of video cameras 102.

In some exemplary embodiments, as described above in detail, the synchronization signal can include a digital bit stream which can include commands and/or data used by programmable registers, programmable timers and other associated circuits in synchronization circuitry 208 in individual video cameras 102 to adjust their internal timing. These command-type synchronization signals can provide timing adjustment commands and/or data specific to particular video camera(s) 102. That is, a command-type synchronization signal specific to a single associated video camera 102 can be generated and transmitted to the associated video camera 102 to adjust the timing of that particular associated video camera 102. These specific command-type synchronization signals can be generated as needed for as many of video cameras 102 as necessary up to and including all of video cameras 102.

As described above, according to exemplary embodiments, video cameras 102 transmit their video image data via standard video image signals, such as NTSC standard video image signals, to video image processing circuitry 104. Video image processing circuitry 104 generates and transmits the synchronization signal to one or more of video cameras 102 during predetermined intervals of the video image signals. Specifically, in some embodiments, video image processing circuitry 104 transmits the synchronization signal(s) to video camera(s) 102 during the vertical blanking interval(s) of the associated video image signal(s) being transmitted to image processing circuitry 104 by the associated video camera(s) 102. To that end, synchronization circuitry 226 can detect the vertical blanking interval of incoming analog video image signals and, in response to detecting the vertical blanking interval, can command signal generation circuit 227 to transmit the synchronization signal.

In some embodiments, video image processing circuitry 104 transmits the synchronization signal(s) to video camera(s) 102 during the horizontal blanking interval(s) (HBI) of one or more of the associated video image signal(s) being transmitted to image processing circuitry 104 by the associated video camera(s) 102. To that end, synchronization circuitry 226 can detect the horizontal blanking interval of incoming analog video image signals and, in response to detecting the horizontal blanking interval, can command signal generation circuit 227 to transmit the synchronization signal.

Video image processing circuitry also includes an electronic control unit (ECU) 230 coupled to multi-channel video decoder 220. Multi-channel video decoder 220 forwards image data for each of the video images generated by video cameras 102 via input/output circuitry 229 to ECU 230, which receives the video image data via input/output circuitry 236. ECU 230 includes a stitching processor 232 which receives the video image data for each individual video camera 102 and stitches the data together to generate a composite video image. Memory 234 is used as required by stitching processor 232 to carry out the stitching operation. The completed stitched composite video image is transmitted by ECU 230 via input/output circuitry 236 to display 106.

According to some exemplary embodiments, multi-channel video decoder 220 can be implemented as an application-specific integrated circuit (ASIC). In some embodiments, this ASIC can operate in one of multiple modes. In a first mode, referred to as a decoding mode, it acts as a video decoder which decodes incoming video image signals. During the vertical blanking interval (or horizontal blanking interval) of a video image signal being processed, it can change modes to a synchronization mode in which it generates and transmits the synchronization signal to video camera 102 which generated the video image signal being processed and/or another of video cameras 102, up to and including all of video cameras 102.

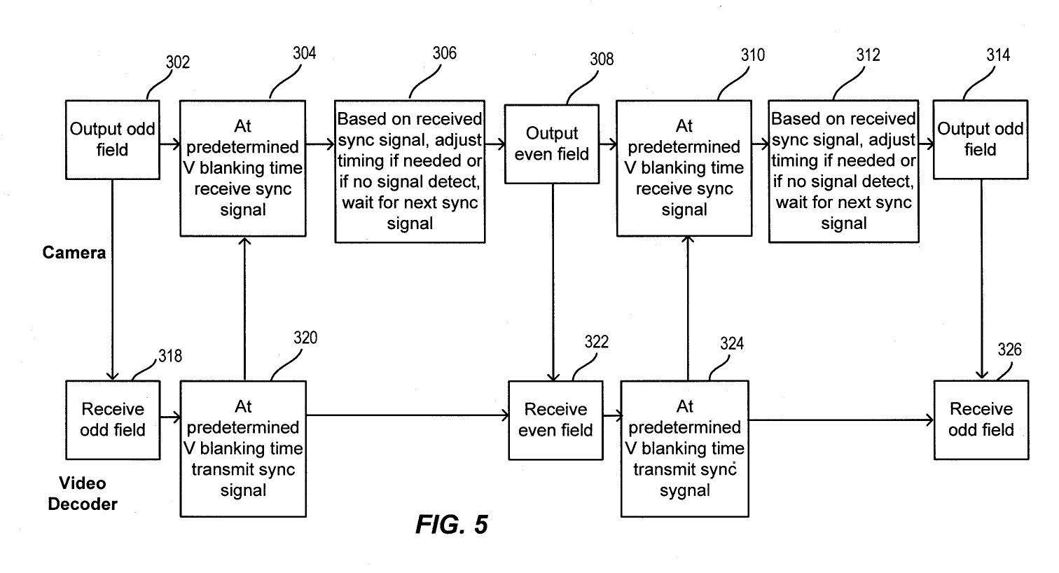

FIG. 5 contains a schematic flow diagram illustrating a process of synchronizing a plurality of video cameras 102 being used in generating a composite video image, according to some exemplary embodiments. Referring to FIG. 5, the steps of the illustrated process shown at the top of the drawing, i.e., steps numbered 302, 304, 306, 308, 310, 312, and 314, are performed in each of video cameras 102, according to some exemplary embodiments; and the steps of the illustrated process shown at the bottom of the drawing, i.e., steps numbered 318, 320, 322, 324, and 326, are performed in multi-channel video decoder 220, according to some exemplary embodiments.

Referring to FIG. 5, in step 302, the odd field data is scanned and output from video camera 102. That is, referring to FIG. 2, the odd-numbered scan lines 130 are processed, and their associated analog video image signals (see FIG. 3) are output from one of video cameras 102. The odd field is received (step 318) at multi-channel video decoder 220. At step 320, the vertical blanking interval of the received analog video image signal is identified by multi-channel video decoder 220, and the synchronization signal is generated and sent back to video camera 102 during the identified vertical blanking interval. In step 304, video camera 102 receives the synchronization signal from multi-channel video decoder 220. In step 306, in video camera 102, based on the received synchronization signal, timing in video camera 102 is adjusted if necessary to synchronize video camera 102 with other video cameras 102 in the system. If no synchronization signal is received, in step 306, video camera 102 waits to receive a synchronization signal.

In step 308, the even field data is scanned and output from video camera 102. That is, referring to FIG. 2, the even-numbered scan lines 133 are processed, and their associated analog video image signals (see FIG. 3) are output from one of video cameras 102. The even field is received (step 322) at multi-channel video decoder 220. At step 324, the vertical blanking interval of the received analog video image signal is identified by multi-channel video decoder 220, and the synchronization signal is generated and sent back to video camera 102 during the identified vertical blanking interval. In step 310, video camera 102 receives the synchronization signal from multi-channel video decoder 220. In step 312, in video camera 102, based on the received synchronization signal, timing in video camera 102 is adjusted if necessary to synchronize video camera 102 with other video cameras 102 in the system. If no synchronization signal is received, in step 312, video camera 102 waits to receive a synchronization signal.

This process repeats for subsequent data frames. That is, in step 314, the next odd field data is output, and, in step 326, the next odd field data is received by video decoder 320. This process is simultaneously performed by all video cameras 102 in the system 100 such that the individual video images obtained by individual video cameras 102 are stitched together by stitching processor 232 in ECU 230 to generate the resulting composite video image.

### Combinations of Features

Various features of the present disclosure have been described above in detail. The disclosure covers any and all combinations of any number of the features described herein, unless the description specifically excludes a combination of features. The following examples illustrate some of the combinations of features contemplated and disclosed herein in accordance with this disclosure.

In any of the embodiments described in detail and/or claimed herein, the sensors can be adapted to use the synchronization signal to adjust timing of the video signals.

In any of the embodiments described in detail and/or claimed herein, the predefined time intervals of the video signals can be vertical blanking intervals of the video signals.

In any of the embodiments described in detail and/or claimed herein, the predefined time intervals of the video signals can be horizontal blanking intervals of the video signals.

In any of the embodiments described in detail and/or claimed herein, the system can include four sensors.

In any of the embodiments described in detail and/or claimed herein, the system can be a surround view system for an automobile.

In any of the embodiments described in detail and/or claimed herein, the decoder can be adapted to generate for each video signal a corresponding signal representative of the video signal.

In any of the embodiments described in detail and/or claimed herein, the system can further comprise an electronic control unit (ECU), the ECU being adapted to receive the corresponding signals from the decoder and combine the corresponding signals to generating data for the image.

In any of the embodiments described in detail and/or claimed herein, the ECU can be adapted to combine the corresponding signals using a stitching operation.

In any of the embodiments described in detail and/or claimed herein, the synchronization signal can include a pulse, the pulse being used by the at least one of the sensors to adjust timing of its associated video signal.

In any of the embodiments described in detail and/or claimed herein, the synchronization signal can include a digital bit stream, the digital bit stream comprising at least one of data and a command used by the at least one of the sensors to adjust timing of its associated video signal.

While the present disclosure makes reference to exemplary embodiments, it will be understood by those of ordinary skill in the art that various changes in form and details may be made therein without departing from the spirit and scope of the present disclosure.

We claim:

1. A system for producing an image, comprising:
a plurality of sensors for detecting light from a subject being imaged, each sensor generating an associated video signal indicative of its detected light, each video signal comprising a predefined time interval; and
a decoder for receiving the video signals from their associated sensors, the decoder detecting the predefined time intervals of the received video signals, generating at least one synchronization signal and transmitting the synchronization signal to at least one of the sensors during the predefined time interval of its associated video signal.

2. The system of claim 1, wherein the sensors are adapted to use the synchronization signal to adjust timing of the video signals.

3. The system of claim 1, wherein the predefined time intervals of the video signals are vertical blanking intervals of the video signals.

4. The system of claim 1, wherein the predefined time intervals of the video signals are horizontal blanking intervals of the video signals.

5. The system of claim 1, wherein the system comprises four sensors.

6. The system of claim 1, wherein the system is a surround view system for an automobile.

7. The system of claim 1, wherein the decoder is adapted to generate for each video signal a corresponding signal representative of the video signal.

8. The system of claim 7, further comprising an electronic control unit (ECU), the ECU being adapted to receive the corresponding signals from the decoder and combine the corresponding signals to generating data for the image.

9. The system of claim 8, wherein the ECU is adapted to combine the corresponding signals using a stitching operation.

10. The system of claim 1, wherein the synchronization signal comprises a pulse, the pulse being used by the at least one of the sensors to adjust timing of its associated video signal.

11. The system of claim 1, wherein the synchronization signal comprises a digital bit stream, the digital bit stream comprising at least one of data and a command used by the at least one of the sensors to adjust timing of its associated video signal.

12. A video decoder, comprising:
a plurality of inputs for receiving a respective plurality of video signals from a respective plurality of associated sensors, each video signal having a predefined time interval; and
a signal generating circuit for generating at least one synchronization signal and transmitting the synchronization signal to at least one of the sensors during the predefined time interval of its associated video signal.

13. The video decoder of claim 12, wherein the predefined time intervals of the video signals are vertical blanking intervals of the video signals.

14. The video decoder of claim 12, wherein the predefined time intervals of the video signals are horizontal blanking intervals of the video signals.

15. The video decoder of claim 12, wherein the video decoder is adapted to receive four video signals.

16. The video decoder of claim 12, wherein the decoder is adapted to generate for each video signal a corresponding signal representative of the video signal.

17. The video decoder of claim 16, wherein the corresponding signals from the video decoder are combinable to generate data for an image.

18. The video decoder of claim 17, wherein the corresponding signals are combinable using a stitching operation.

19. The video decoder of claim 12, wherein the synchronization signal comprises a pulse, the pulse being used by the at least one of the sensors to adjust timing of its associated video signal.

20. The video decoder of claim 12, wherein the synchronization signal comprises a digital bit stream, the digital bit stream comprising at least one of data and a command used by the at least one of the sensors to adjust timing of its associated video signal.

21. A method for producing an image, comprising:
detecting light from a subject being imaged using a plurality of sensors, each sensor generating an associated video signal indicative of its detected light, each video signal comprising a predefined time interval; and
receiving the video signals from their associated sensors using a decoder, the decoder detecting the predefined time intervals of the received video signals, generating at least one synchronization signal and transmitting the synchronization signal to at least one of the sensors during the predefined time interval of its associated video signal.

22. The method of claim 21, wherein the sensors use the synchronization signal to adjust timing of the video signals.

23. The method of claim 21, wherein the predefined time intervals of the video signals are vertical blanking intervals of the video signals.

24. The method of claim 21, wherein the predefined time intervals of the video signals are horizontal blanking intervals of the video signals.

25. The method of claim 21, wherein, for each video signal, the decoder generates a corresponding signal representative of the video signal.

26. The method of claim 25, further comprising combining the corresponding signals to generating data for the image.

27. The method of claim 26, wherein the combining comprises performing a stitching operation.

28. The method of claim 21, wherein the synchronization signal comprises a pulse, the pulse being used by the at least one of the sensors to adjust timing of its associated video signal.

29. The method of claim 21, wherein the synchronization signal comprises a digital bit stream, the digital bit stream comprising at least one of data and a command used by the at least one of the sensors to adjust timing of its associated video signal.

30. A video decoding method, comprising:
receiving a plurality of video signals from a respective plurality of associated sensors, each video signal having a predefined time interval; and
generating a synchronization signal and transmitting the synchronization signal to each sensor during the predefined time interval of its associated video signal.

31. The method of claim 30, wherein the predefined time intervals of the video signals are vertical blanking intervals of the video signals.

32. The method of claim 30, wherein the predefined time intervals of the video signals are horizontal blanking intervals of the video signals.

33. The method of claim 30, wherein four video signals are received.

34. The method of claim 30, further comprising, for each video signal, generating a corresponding signal representative of the video signal.

35. The method of claim 34, further comprising combining the corresponding signals to generate data for an image.

36. The method of claim 35, wherein the combining comprises performing a stitching operation.

37. The method of claim 30, wherein the synchronization signal comprises a pulse, the pulse being used by the at least one of the sensors to adjust timing of its associated video signal.

38. The method of claim 30, wherein the synchronization signal comprises a digital bit stream, the digital bit stream comprising at least one of data and a command used by the at least one of the sensors to adjust timing of its associated video signal.
